(19) United States
(12) Patent Application Publication
(10) Pub. No.: US 2002/0054226 A1
(43) Pub. Date: May 9, 2002

(54) CMOS image sensor and method for fabricating the same

(76) Inventor: Won-Ho Lee, Ichon-shi (KR)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/924,301

(22) Filed: Aug. 8, 2001

(30) Foreign Application Priority Data
Aug. 18, 2000 (KR) 2000-47841

(51) Int. Cl. H04N 3/14

(52) U.S. Cl. 348/308

(57) ABSTRACT

A CMOS image sensor having spacers on sidewalls of a gate electrode in an unsymmetrical form is provided to increase a voltage swing width and reduce a dark current. The CMOS image sensor includes: a semiconductor structure having an impurity region and a gate electrode; a first spacer formed on one sidewall of the gate electrode, wherein the first spacer is overlapped with a portion of the impurity region; a second spacer formed on a sidewall of the first spacer; and a third spacer formed on the other sidewall of the gate electrode.

### FIELD OF THE INVENTION

The present invention relates generally to an image sensor, and more particularly, to a complementary metal oxide semiconductor (CMOS) image sensor for increasing a voltage swing width and reducing a dark current.

### BACKGROUND OF THE INVENTION

As is well known, an image sensor is an apparatus for sensing a light beam reflected from an object to generate an image data. Especially, an image sensor fabricated by using a complementary metal oxide semiconductor (CMOS) technology is called a CMOS image sensor.

Generally, the CMOS image sensor includes a plurality of unit pixels. Each of the unit pixels also includes a light sensing element and a plurality of transistors. The light sensing element, such as a photodiode, detects incident light beam to generate photoelectric charges corresponding to an amount of the incident light beam. The transistors perform switching operations to control a transfer of the photoelectric charges.

FIG. 1 is a circuit diagram showing a unit pixel 10 contained in a conventional CMOS image sensor. Here, a reference symbol ML represents a load transistor for controlling a current that flows via an output node NO of the unit pixel 10. Referring to FIG. 1, the illustrated unit pixel 10 includes a photodiode 12 and four transistors. In particular, the four transistors include a transfer transistor MT, a reset transistor MR, a drive transistor MD and a select transistor MS.

The photodiode 12 senses an incident light to generate photoelectric charges. The transfer transistor MT, coupled between the photodiode 12 and a sensing node NS, transfers the photoelectric charges to the sensing node NS. The reset transistor MR, coupled between a power terminal VDD and the sensing node NS, transfers a reset voltage level from a voltage source to the photodiode 12 and the drive transistor MD.

The drive transistor MD, whose drain is coupled to the power terminal VDD, amplifies a voltage level of the sensing node NS to output an amplified signal. The select transistor MS, coupled between the drive transistor MD and an output node NO, performs a switching operation to output the amplified signal as an image data via the output node NO.

FIG. 2 is a cross-sectional view showing a conventional CMOS image sensor. Referring to FIG. 2, a field oxide layer 21 is formed on a semiconductor substrate 20, and an N-type impurity region 22 and a P-type impurity region 23 are formed on the semiconductor substrate 20, thereby providing a photodiode 24. Then, a floating diffusion region 25 that is spaced away from the N-type impurity region 22 is formed on the semiconductor substrate 20.

A gate oxide layer 26 and a gate electrode 27 are sequentially formed between the P-type impurity region 23 and the floating diffusion region 25. Then, spacers 28A and 28B are formed on sidewalls of the gate electrode 27.

As can be seen, the two spacers 28A and 28B formed on the sidewalls of the gate electrode 27 are symmetrical with each other. That is, a first spacer length L1 is identical to a second spacer length L2. If the second spacer length L2 becomes increasingly longer, a dark current is reduced, but a gate overlap capacitance in the floating diffusion region 25 is increased. As a result, the increase of the gate overlap capacitance in the floating diffusion region 25 leads to a reduction of a voltage swing width therein.

In contrast, if the second spacer length L2 is decreased, the voltage swing width in the floating diffusion region 25 is increased. However, the decrease of the second overlap length L2 leads the first spacer length L1 to decrease also, so that the dark current is increased.

### SUMMARY OF THE INVENTION

In accordance with an embodiment of the present invention, there is provided a CMOS image sensor comprising: a semiconductor substrate having an impurity region and a gate electrode; a first spacer formed on a first sidewall of the gate electrode, wherein the first spacer is overlapped with a portion of the impurity region; a second spacer formed on a sidewall of the first spacer; and a third spacer formed on a second sidewall of the gate electrode.

In accordance with another embodiment of the present invention, there is provided a method for fabricating a CMOS image sensor, comprising: a) providing a semiconductor structure, wherein the semiconductor structure includes an impurity region and a gate electrode; b) forming a first spacer on a first sidewall of the gate electrode, wherein the first spacer is overlapped with a portion of the impurity region; and c) forming a second spacer on a sidewall of the first spacer and a third spacer on a second sidewall of the gate electrode.

In accordance with further another embodiment of the present invention, there is provided a method for fabricating a CMOS image sensor, comprising: a) providing a semiconductor structure, wherein the semiconductor structure includes an impurity region and a gate electrode formed on a semiconductor substrate; b) forming a first nitride layer on the semiconductor structure; c) exposing the gate electrode and a portion of the impurity region; d) forming a first spacer on a first sidewall of the gate electrode; and e) forming a second spacer on a sidewall of the first spacer and a third spacer on a second sidewall of the gate electrode.

### BRIEF DESCRIPTION OF THE DRAWINGS

Objects and aspects of the invention will become apparent from the following description of the preferred embodiments with reference to the accompanying drawings, in which:

FIG. 1 is a circuit diagram showing a unit pixel contained in a conventional CMOS image sensor;

FIG. 2 is a cross-sectional view showing a conventional CMOS image sensor;

FIG. 3 is a cross-sectional view illustrating a CMOS image sensor constructed in accordance with the teachings of the present invention;

FIGS. 4A to 4E are cross-sectional views illustrating sequential steps of fabricating the CMOS image sensor shown in FIG. 3 in accordance with the teachings of the present invention; and

FIGS. 5A to 5G are cross-sectional views illustrating sequential steps of fabricating the CMOS image sensor shown in FIG. 3 of an alternate embodiment in accordance with the teachings of the present invention.

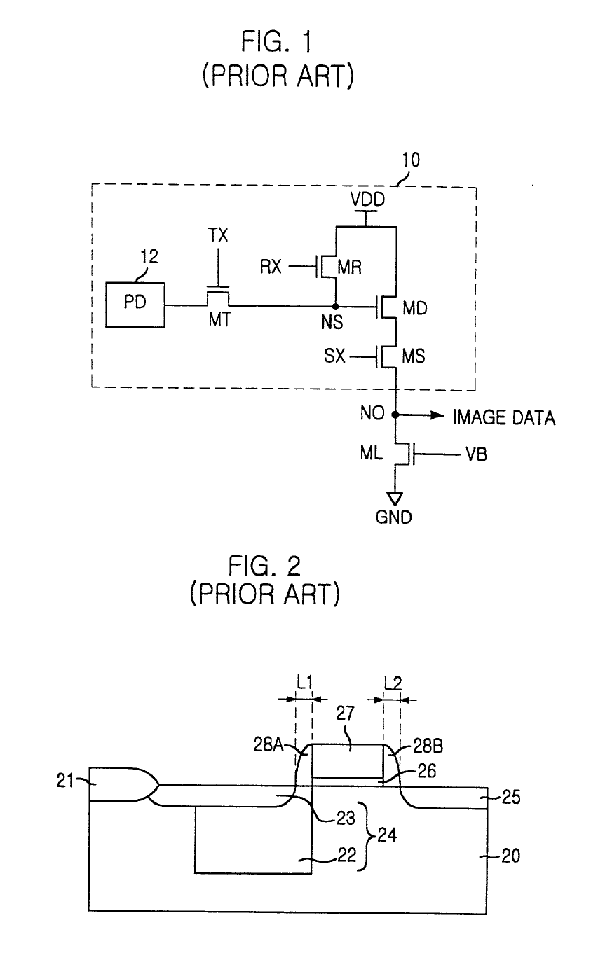

### DETAILED DESCRIPTION OF THE PREFERRED EMBODIMENTS

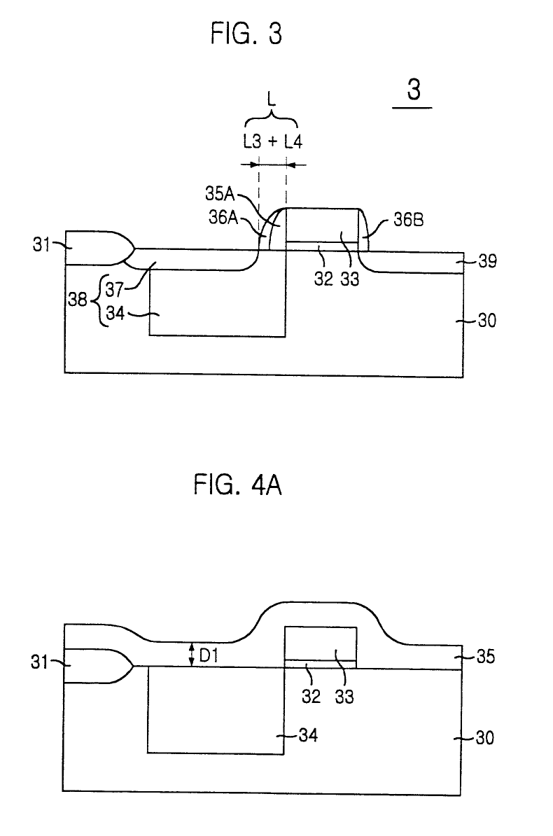

Referring to FIG. 3, a CMOS image sensor 3 constructed in accordance with teachings of the present invention includes a semiconductor substrate 30 having an N-type impurity region 34, a gate oxide layer 32 and a gate electrode 33. A first spacer 35A formed on one sidewall of the gate electrode 33, a second spacer 36A formed on one sidewall of the first spacer 35A, and a third spacer 36B formed on the other sidewall of the gate electrode 33. The first spacer 35A is overlapped with a portion of the N-type impurity region 34. The first spacer 35A, the second spacer 36A and the third spacer 36B can be formed with oxide layers by carrying out a thermal oxidation process.

Furthermore, the CMOS image sensor 3 includes a P-type impurity region 37 formed on the N-type impurity region 34 to thereby provide a photodiode 38, and a floating diffusion region 39 that is spaced away from the N-type impurity region 34 by a length of the gate electrode 33.

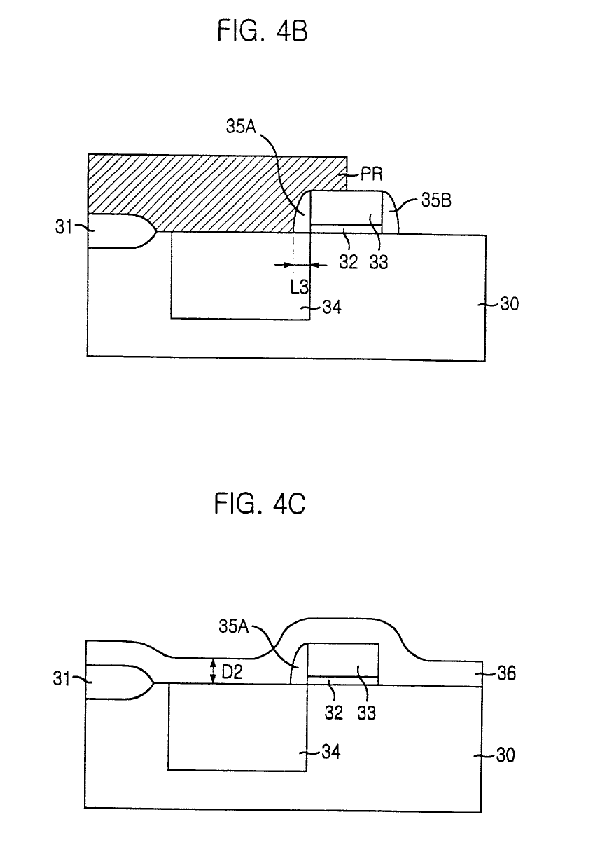

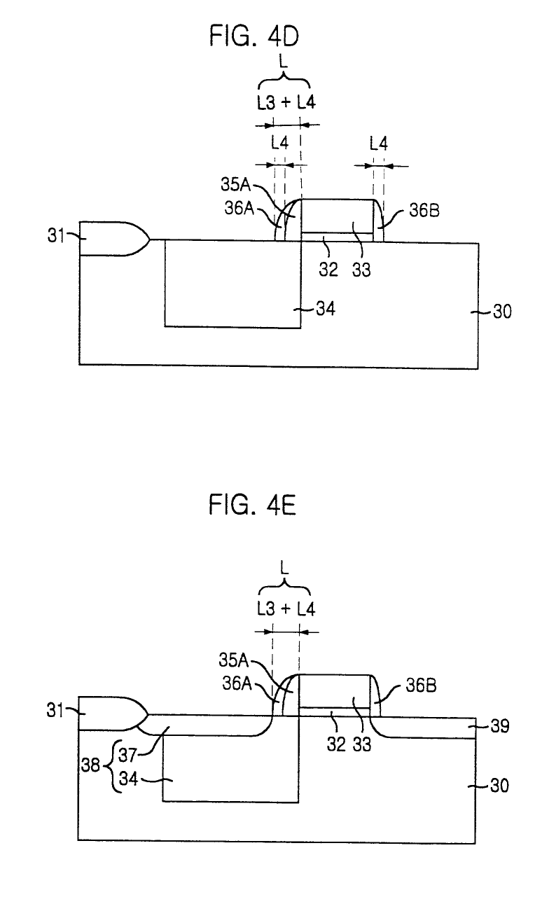

FIGS. 4A to 4E illustrate sequential steps of fabricating the CMOS image sensor 3 shown in FIG. 3 in accordance with the teachings of the present invention.

Referring to FIG. 4A, a field oxide layer 31, a gate oxide layer 32 and a gate electrode 33 are formed on a semiconductor substrate 30. Then, N-type impurities are ion-implanted to form an N-type impurity region 34. Thereafter, a thermal oxidation process is carried out to form a first oxide layer 35 on the entire substrate structure 30. Here, a depth D1 of the first oxide layer 35 is determined with a consideration of a spacer length to be overlapped with the N-type impurity region 34.

As shown in FIG. 4B, an etching process is carried out to form a first spacer 35A that overlaps with the N-type impurities region 34 on one sidewall of the gate electrode 33. Additionally, a second spacer 35B is formed on the other sidewall of the gate electrode 33. A spacer length L3 of the first spacer 35A is identical to that of the second spacer 35B. Then, a photoresist pattern PR is form to cover the N-type impurity region 34 and the first spacer 35A.

Referring to FIG. 4C, the photoresist pattern PR is removed after removing the second spacer 35B by using an etching process. Then, a thermal oxidation process is carried out to form a second oxide layer 36 on the entire substrate structure 30. A depth D2 of the second oxide layer 36 is determined with a consideration of a spacer length to be overlapped with the N-type impurity region 34.

Referring to FIG. 4D, an etching process is carried out to form a third spacer 36A on a sidewall of the first spacer 35A and a fourth spacer 36B on the other sidewall of the gate electrode 33 and the gate oxide layer 32, respectively. A spacer length L4 of the third spacer 36A is identical to that of the fourth spacer 36B. Consequently, a total spacer length L overlapped with the N-type impurity region 34 is a sum of the spacer length L3 and the spacer length L4.

Referring to FIG. 4E, a selective ion implantation is carried out to form a P-type impurity region 37 on the N-type impurity region 34, thereby providing a photodiode 38. Then, an ion plantation process is carried out to form a floating diffusion region 39 spaced away from the N-type impurity region 34 by a length of the gate electrode 33.

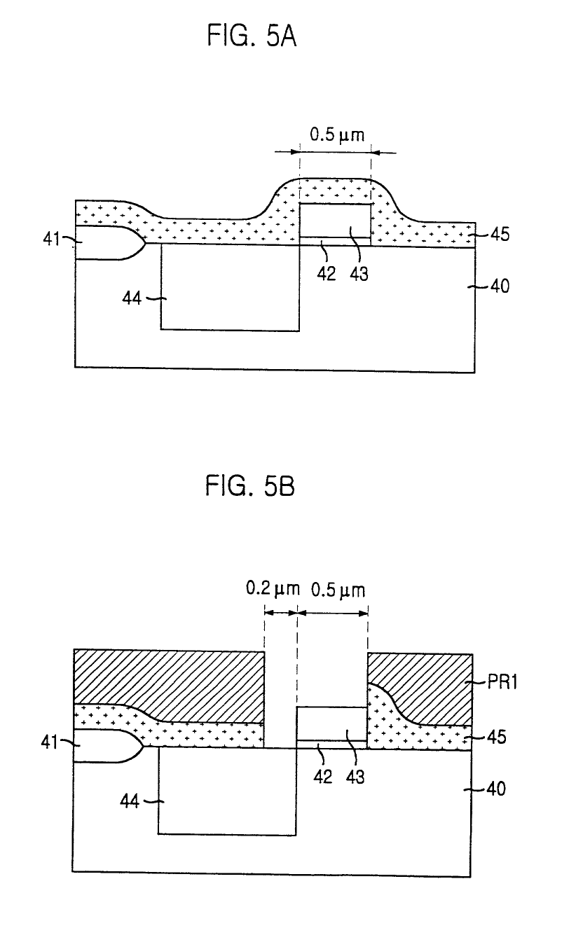

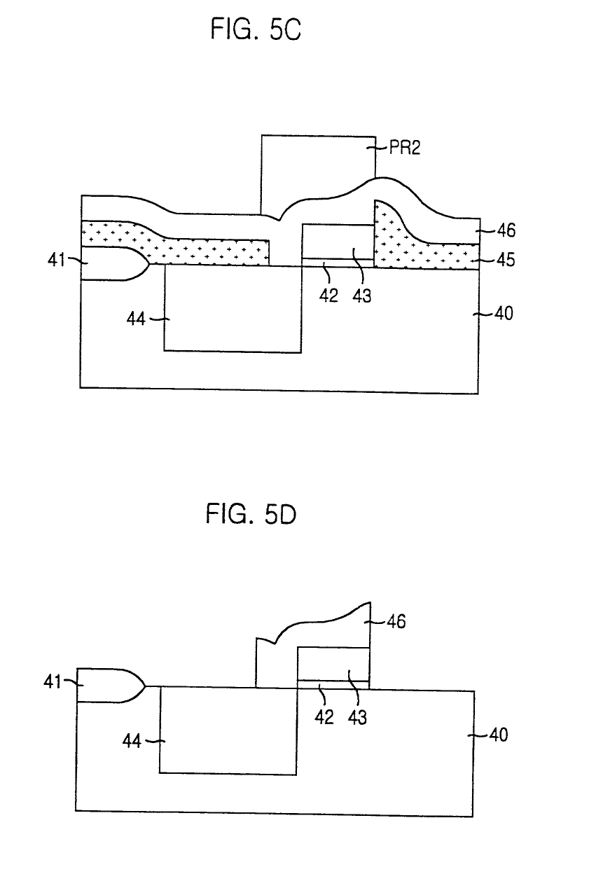

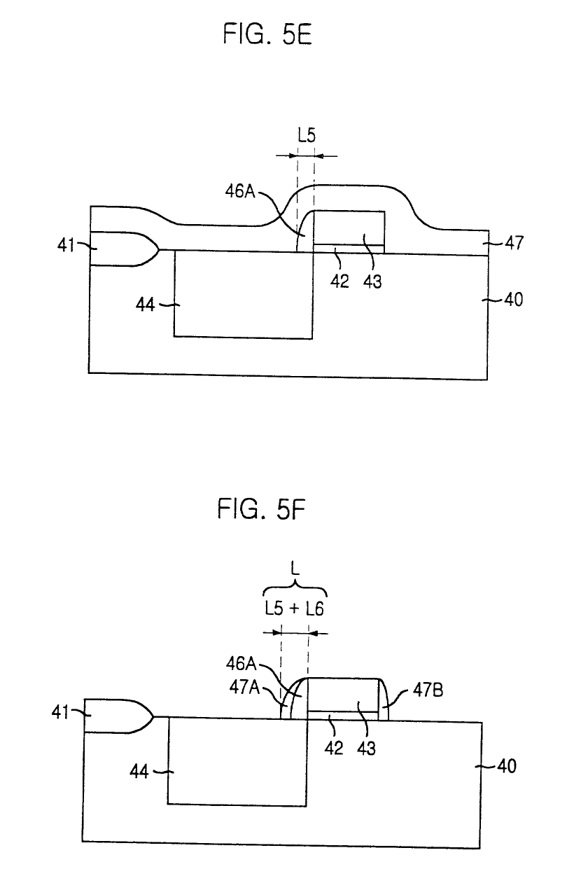

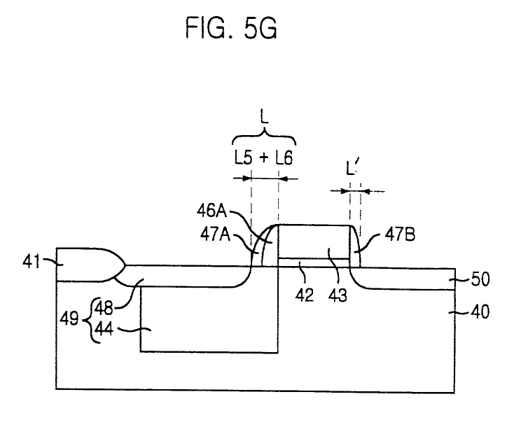

FIGS. 5A to 5G illustrate sequential steps of fabricating the CMOS image sensor 3 shown in FIG. 3 of an alternate embodiment in accordance with the teachings of the present invention.

Referring to FIG. 5A, a field oxide layer 41, a gate oxide layer 42 and a gate electrode 43 are formed on a semiconductor substrate 40. Then, N-type impurities are ion-implanted to form an N-type impurity region 44. Thereafter, a thermal oxidation process is carried out to form a first nitride layer 45 on the entire substrate structure. Preferably, the gate electrode 43 is formed to a line width of about 0.5 μm.

Referring to FIG. 5B, a photoresist pattern PR1 is formed, and an etching process is carried out to expose the gate electrode 43 and a portion of the N-type impurity region 44. An exposed length of the N-type impurity region 44 is determined with a consideration of a spacer length to be overlapped with the N-type impurity region 44. Preferably, the N-type impurity region 44 is exposed as long as 0.2 μm.

Referring to FIG. 5C, after removing the photoresist pattern PR1, a chemical vapor deposition (CVD) is carried out to deposit a first oxide layer 46 on the entire substrate structure. Then, a photoresist pattern PR2 covers the exposed portion of the N-type impurity region 44 and the gate electrode 43 formed on the first oxide layer 46.

Referring to FIG. 5D, the oxide layer 46 and the nitride layer 45 are patterned using the photoresist pattern PR2 as a mask, and the photoresist pattern PR2 is then removed.

Referring to FIG. 5E, the first oxide layer 45 is etched to form a first spacer 46A having a predetermined first spacer length L5, and a chemical vapor deposition (CVD) is carried out to form a second oxide layer 47 on the entire substrate structure.

Referring to FIG. 5F, the second oxide layer 47 is etched to form a second spacer 47A on a sidewall of the first spacer 46A and a third spacer 47B on the other sidewall of the gate electrode 43. A second spacer length L6 of the second spacer 47A is identical to that of the third spacer 47B. Consequently, a total spacer length L overlapped with the N-type impurity region 44 is a sum of the first spacer length L5 and the second spacer length L6.

Referring to FIG. 5G, a selective ion implantation is carried out to form a P-type impurity region 48 on the N-type impurity region 44, thereby providing a photodiode 49. Then, an ion plantation process is carried out to form a floating diffusion region 50 spaced away from the N-type impurity region 44 by a length of the gate electrode 43.

As described above, the CMOS image sensor 3 constructed in accordance with the teachings of the present invention has spacers formed on the sidewalls of the gate electrode 43 in an unsymmetrical form. That is, the spacer length L overlapped with the N-type impurity region 44 disposed in the photodiode 49 is longer than the space length L′ overlapped with the floating diffusion region 50. As a result, a gate overlap capacitance in the floating diffusion region 50 is reduced and the spacer length L overlapped with the N-type impurity region 44 disposed in the photodiode 49 is increased, thereby increasing a voltage swing width and decreasing the dark current.

Although certain method and apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A CMOS image sensor comprising:
a semiconductor substrate having an impurity region and a gate electrode;
a first spacer formed on a first sidewall of the gate electrode, wherein the first spacer is overlapped with a portion of the impurity region;
a second spacer formed on a sidewall of the first spacer; and
a third spacer formed on a second sidewall of the gate electrode.

2. The CMOS image sensor as recited in claim 1, wherein the first spacer, the second spacer and the third spacer are formed with oxide layers.

3. The CMOS image sensor as recited in claim 2, wherein the first spacer, the second spacer and the third spacer are formed by carrying out a thermal oxidation process.

4. The CMOS image sensor as recited in claim 1, wherein the impurity region is an N-type.

5. The CMOS image sensor as recited in claim 4, further comprising:
a P-type impurity region formed on the impurity region to provide a photodiode; and
a floating diffusion region spaced away from the impurity region by a predetermined distance.

6. A method for fabricating a CMOS image sensor, comprising:
a) providing a semiconductor structure, wherein the semiconductor structure includes an impurity region and a gate electrode;
b) forming a first spacer on a first sidewall of the gate electrode, wherein the first spacer is overlapped with a portion of the impurity region; and
c) forming a second spacer on a sidewall of the first spacer and a third spacer on a second sidewall of the gate electrode.

7. The method as recited in claim 6, comprising:
b1) forming a first oxide layer on the semiconductor structure; and
b2) carrying out an etching process to form the first spacer.

8. The method as recited in claim 7, comprising forming the first oxide layer by carrying out a thermal oxidation process.

9. The method as recited in claim 7, additionally 2 comp rising forming a fourth spacer on the other sidewall of the gate electrode.

10. The method as recited in claim 9, comprising:
c1) forming a photoresist pattern covering the impurity region and the first spacer;
c2) carrying out an etching process to remove the fourth spacer;
c3) removing the photoresist pattern;
c4) forming a second oxide layer on a resulting substrate; and
c5) carrying out an etching process to form the second spacer and the third spacer.

11. The method as recited in claim 10, comprising forming the second oxide layer by carrying out a thermal oxidation process.

12. The method as recited in claim 6, wherein the impurity region is an N-type.

13. The method as recited in claim 12, additionally comprising:
d) carrying an ion implantation to form a P-type impurity region on the impurity region to thereby obtain a photodiode; and
e) forming a floating diffusion region spaced away from the impurity region by a predetermined distance.

14. A method for fabricating a CMOS image sensor, comprising:
a) providing a semiconductor structure, wherein the semiconductor structure includes an impurity region and a gate electrode formed on a semiconductor substrate;
b) forming a first nitride layer on the semiconductor structure;
c) exposing the gate electrode and a portion of the impurity region;
d) forming a first spacer on a first sidewall of the gate electrode; and
e) forming a second spacer on a sidewall of the first spacer and a third spacer on a second sidewall of the gate electrode.

15. The method as recited in claim 14, comprising:
c1) depositing a first oxide layer on the semiconductor structure by carrying out a chemical vapor deposition (CVD);
c2) forming a photoresist pattern on the first oxide layer, wherein the photoresist covers an exposed portion of the impurity region and the gate electrode;
c3) patterning the first oxide layer and the nitride layer by using the photoresist pattern as a mask;
c4) removing the photoresist pattern; and
c5) carrying out an etching process to form the first spacer.

16. The method as recited in claim 14, comprising:
e1) forming a second oxide layer on a resulting structure; and
e2) carrying out an etching process to form the second spacer and the third spacer.

17. The method as recited in claim 14, wherein the impurity region is an N-type.

18. The method as recited in claim 17, additionally comprising:
f) carrying an ion implantation to form a P-type impurity region on the impurity region to thereby obtain a photodiode; and
g) forming a floating diffusion region spaced away from the impurity region by a length of the gate electrode.
